(19) United States
(12) Patent Application Publication
(10) Pub. No.: US 2008/0108759 A1
(43) Pub. Date: May 8, 2008

(54) Lactic Acid Polymers

(76) Inventors: Nils Dan Anders Sodergard, Turku (FI); Erik Mikael Stolt, Turku (FI); Saara Inkinen, Turku (FI)

Correspondence Address: WILLIAMS, MORGAN & AMERSON, 10333 RICHMOND, SUITE 1100, HOUSTON, TX, 77042, US

(21) Appl. No.: 11/936,170

(22) Filed: Nov. 7, 2007

Related U.S. Application Data
(60) Provisional application No. 60/911,557, filed on Apr. 13, 2007.

(30) Foreign Application Priority Data
Nov. 8, 2006 (GB) 0622263.2

(51) Int. Cl. C08G 63/08

(52) U.S. Cl. 525/450

(57) ABSTRACT

The incorporation of units derived from isosorbide and from a polycarboxylic acid or anhydride thereof in a lactic acid polymer can result in a polymer having a higher glass transition temperature than would otherwise be achieved.

The present invention relates to improved polylactic acid polymers.

In recent years, as environmental issues have become increasingly important, the need for polymers which are biodegradable but stable during normal conditions of use has increased, especially for the packaging of food and drinks. Polymers based on lactic acid can be biodegradable and may be of food grade, and so, potentially, could be of interest for such purposes.

Lactic acid can form polymers by polymerisation using a mono, di-, tri-, tetra-, or polyfunctional initiator, for example compounds with hydroxy and/or acid groups. However, such polymers tend to have a low glass transition temperature and, consequently, are of restricted value for the preparation of rigid or semi-rigid containers, such as bottles. High molecular weight polymers formed by the ring opening polymerisation of lactide have a high molecular weight, but, despite that, the glass transition temperature is lower than that of plastics commonly used in rigid packages, e.g. polyethylene terephthalate and polystyrene. Furthermore, lactide is made by the polycondensation of lactic acid and subsequent decomposition of the resulting low molecular weight polylactic acid. These steps add complexity and expense to the preparation process and it would, therefore, be desirable if suitable polymers could be produced directly by the polymerisation of lactic acid.

Isosorbide has been incorporated into polymers of various types in order to achieve a variety of benefits. For example, WO2004044032A1 discloses that isosorbide can be used to raise the glass transition temperature of polyesters. Other patents disclosing the use of isosorbide for various purposes include DE 2938464, U.S. Pat. No. 6,656,577, U.S. Pat. No. 7,049,390, U.S. Pat. No. 6,818,730, U.S. Pat. No. 6,063,495, U.S. Pat. No. 6,063,465, and U.S. Pat. No. 5,959,066.

We have now discovered that the incorporation into a lactic acid polymer of units derived from isosorbide and units derived from a polycarboxylic acid can give a polymer having the desired higher glass transition temperature. Although isosorbide is known to elevate the glass transition temperature in certain other polymers, we have surprisingly found that isosorbide alone is ineffective in lactic acid polymers and the presence of a polycarboxylic acid is necessary if the desired results are to be achieved. Similar advantages may be expected by the incorporation of these units into polylactide polymers. Moreover, by appropriate selection of the relative amounts of the components of the polymer, it is possible to ensure that the polymer has a relatively high degradation temperature, an important consideration for materials used by the public.

Thus, the present invention consists in a polymer comprising units derived from: lactic acid; isosorbide; and a polycarboxylic acid having at least three carboxylic acid groups, the lactic acid units comprising at least 50 weight % of the polymer.

The invention further consists in a process for preparing a lactic acid polymer, which comprises polymerising lactic acid, isosorbide and a polycarboxylic acid having at least three carboxylic acid groups or anhydride thereof, the lactic acid comprising at least 50 weight % of the polymer components.

The invention further consists in a process for preparing a lactic acid polymer, which comprises polymerising lactide, isosorbide and a polycarboxylic acid having at least three carboxylic acid groups or anhydride thereof, the lactide being present in sufficient amount to provide at least 50 weight % of lactic acid units in the lactic acid polymer.

The polymerisation reactions of the present invention may be carried out under any conditions known in the art for the polymerisation of such monomers, but is preferably carried out in the presence of a catalyst, and preferably with heating. Any catalyst known for use in such polymerisation reactions may equally be used here, and examples of suitable catalysts include such esterification catalysts as: acids, such as p-toluenesulphonic acid or sulphuric acid; metallic or organometallic compounds containing elements of groups I-VIIIA and/or groups IB-VIIB in the Periodic Table of Elements, including compounds of lithium, calcium, magnesium, manganese, zinc, lead, titanium, germanium, antimony, cobalt, or tin, especially compounds of titanium, germanium, antimony, cobalt, or tin, for example titanium (IV) butoxide or titanium acetylacetonate.

The polymerisation reaction may take place at ambient temperature, depending on the catalyst and monomers used, but is preferably carried out with heating, e.g. to a temperature of from 100° C. to 250° C., more preferably 140° C. to 210° C., and most preferably from 150° C. to 190° C.

The reaction is carried out under conditions such as to remove the water formed in the course of the reaction, i.e. at temperature of at least 100° C. and preferably under sub-atmospheric pressure, more preferably under vacuum.

The reaction is preferably carried out in the absence of any solvent other than the reagents, but, if desired, an organic solvent may be present. If used, examples of such organic solvents include: ethers, such as diphenyl ether, and dioxane; and hydrocarbons, such as toluene, xylene, and dodecane

The reaction is preferably carried out under essentially anhydrous conditions.

The lactic acid is the major component of the reaction mixture, and is present in sufficient amount to make up at least 50 weight % of the polymer, preferably at least 60%, more preferably from 65 to 90% and most preferably from 65 to 75%. The lactic acid may be L, D or DL.

The isosorbide is present in a minor proportion in the final polymer, for example no more than 20 weight %, and we prefer to use sufficient to provide from 2 to 20 weight % of units in the final polymer, more preferably from 2 to 15% and most preferably from 5 to 11%.

The polycarboxylic acid or anhydride thereof is a compound having at least three, and preferably from three to six, carboxylic acid groups, or is an anhydride of such a compound. It should be capable of reacting with the isosorbide, and examples of suitable such acids include: 1,2,3,4,5,6,-cyclohexanehexacarboxylic acid, 1,2,3,4-butanetetracarboxylic acid, trimellitic acid, pyromellitic acid. Anhydrides of these acids may also be used. The preferred polycarboxylic acids are 1,2,3,4,5,6,-cyclohexanehexacarboxylic acid and 1,2,3,4-butanetetracarboxylic acid. The carboxylic acid compound is also preferably present in a minor proportion in the final polymer, for example no more than 20 weight %, and we prefer to use sufficient to provide from 3 to 20 weight % of units in the final polymer, more preferably from 4 to 18% and most preferably from 5 to 11%.

In addition to the lactic acid or lactide, isosorbide and polycarboxylic acid or anhydride, other monomers may be included in the polymerisation reaction and so in the final polymer, if desired. Examples of such monomers include: other hydroxy acids, such as glycolic acid, hydroxybutyric acid, or hydroxycaproic acid. If used, such additional monomers are preferably present in minor amounts.

For practical use, the copolymers of the present invention are preferably formulated with conventional additives commonly used in the plastics industry, such as plasticisers, fillers, colouring agents, etc. also, if desired, the copolymers may be formulated as compositions in admixture with at least one polyester (different from the copolymer of the present invention) such as a polylactide.

The resulting polymers or compositions may be formed into films or shaped articles, such as containers, for example bottles or boxes, by known means, and are especially suitable for packaging of substances for human or animal consumption, for example food, electronic equipment or medicines.

The invention is further illustrated by the following non-limiting Examples.

### EXAMPLES 1-9

### (a) Drying of Lactic Acid

The lactic acid was dried using a rotary evaporator attached to a water cooler. A known amount of lactic acid was placed into a bottle beaker, which was heated in an oil bath under atmospheric pressure. The bottle was placed in the oil bath at ambient temperature and the temperature was raised to 180° C. within approximately 30 minutes and kept at this temperature for 4 hours from placing the bottle in the oil bath. After this, the bottle was capped and allowed to cool to ambient temperature. The lactic acid was dried separately for all the polymerisations, and a sample was taken from four batches for the determination of the acid number by titration.

### (b) Polymerisation Procedure

The polymerisations were conducted in vacuum using a rotary evaporator attached to a water cooler. The polymerisation temperature was 150° C., and it was reached within about 30 minutes after starting the heating from approximately 22° C. The pressure setting of the vacuum pump was lowered slowly from about 800 mbar to 1 mbar over 4 hours after the temperature had reached 150° C. After the pressure setting had been lowered to 1 mbar, the polymerisation was continued at 150° C. for a minimum of 54 hours. The vacuum pump was stopped and the beaker removed to allow samples to be taken after specific time intervals, after which the pressure was lowered to vacuum immediately.

### (c) Differential Scanning Calorimetry (DSC)

The Differential Scanning Calorimetry (DSC) instrument used to measure the thermal transitions was a Perkin Elmer (Bucks, United Kingdom) DSC 7. The DSC equipment was calibrated with indium and an empty pan was used as a reference. The samples were weighed into an aluminium pan and hermetically sealed. The samples were first heated from −30° C. to 200° C., and then cooled back to −30° C., after which a second heating scan similar to the first one was performed. Both the heating and the cooling rates were 10° C./min. The GPC results are presented for the conventional calibration technique, which uses the refractive index detector and the results are not dependent on knowledge of the absolute concentration of the sample.

The results are shown in the following Table 1.

TABLE 1

| | LLA | BTCA | | ISB | Time | Tg | | | |
|---|---|---|---|---|---|---|---|---|---|
| Ex. No. | (%) | (%) | | (%) | (h) | (° C.) | Mn | Mw | Mz |
| 1 | 85.6 | 8.8 | | 5.5 | 5.5 | 13.47 | 807 | 1006 | 1284 |
| | | | | | 24 | 44.31 | 1958 | 4360 | 7528 |
| | | | | | 30 | 50.84 | 2204 | 5491 | 9814 |
| | | | | | 48 | 55.49 | 2931 | 9924 | 53800 |
| | | | | | 54 | 56.31 | 3636 | 14980 | 64600 |
| 2 | 88.3 | 8.8 | | 2.8 | 9 | 29.75 | 1248 | 13520 | 152600 |
| | | | | | 24 | 47.04 | 1624 | 13160 | 425600 |
| | | | | | 54 | 59.78 | | | |
| 3 | 80.1 | 8.8 | | 11.0 | 7 | 20.43 | 925 | 21560 | 286700 |
| | | | | | 24 | 46.57 | 1481 | 3479 | 6081 |
| | | | | | 54 | 59.18 | | | |
| 4 | 90.0 | 4.4 | | 5.5 | 5.5 | 7.95 | 639 | 785 | 982 |
| | | | | | 24 | 39.14 | 1446 | 3748 | 7499 |
| | | | | | 32.5 | 44.59 | 2429 | 6706 | 19990 |
| | | | | | 48 | 46.63 | 2782 | 9003 | 19370 |
| | | | | | 54 | 47.08 | 3549 | 17260 | 186100 |
| 5 | 76.8 | 17.6 | | 5.5 | 8 | 38.38 | 697 | 1121 | 1740 |
| | | | | | 24 | 50.03 | 933 | 1980 | 3524 |
| | | | | | 54 | 61.88 | | | |
| 6 | 71.6 | 17.4 | | 10.9 | 8.75 | 37.09 | 1358 | 2112 | 3242 |
| | | | | | 24 | 55.7 | 2256 | 4379 | 7564 |
| | | | | | 34 | 59.83 | 1903 | 4058 | 7114 |
| | | | | | 48.5 | 62.48 | 1912 | 5085 | 9960 |
| | | | | | 54 | 63.67 | 1042 | 3623 | 9452 |
| 7 | 85.0 | — | 15.0 | — | 12 | 6.76 | 709 | 958 | 1287 |
| (Comp) | | | | | 24 | 15.02 | 761 | 1218 | 1783 |
| | | | | | 36 | 15.39 | 789 | 1344 | 2040 |
| | | | | | 48 | 13.34 | 685 | 1138 | 1736 |
| | | | | | 60 | 9.23 | 564 | 895 | 1300 |
| | | | | | 72 | 9.66 | 525 | 822 | 1198 |
| 8 | 100 | — | — | — | 10 | 14.30 | 863 | 1333 | 2001 |
| (Comp) | | | | | 24 | 32.72 | 1806 | 3508 | 5663 |
| | | | | | 30 | 37.57 | 2115 | 4176 | 6645 |
| | | | | | | | 2447 | 4510 | 6964 |
| | | | | | 48 | 41.89 | 3007 | 7001 | 12250 |
| | | | | | 54 | 39.68 | 3800 | 7986 | 13680 |
| 9 | 91.1 | 8.8 | — | — | 9 | 27.23 | 1755 | 91370 | 1079000 |
| (Comp) | | | | | 24 | 46.51 | 1410 | 4159 | 17520 |
| | | | | | 33.75 | 50.21 | 4539 | 24390 | 35200 |
| | | | | | 48 | 50.91 | 1808 | 7074 | 73230 |
| | | | | | 54 | 50.66 | 1682 | 3649 | 5809 |

In the Table, the following abbreviations are used:

LLA=L-lactic acid

BTCA=butanetetracarboxylic acid

ISB=isosorbide

Tg=glass transition temperature

h=hours

Mn=number average molecular weight

Mw=weight average molecular weight

Mz=z average molecular weight

Comp=comparative, i.e. not an example of the invention.

### EXAMPLES 10-18

### (a) Drying of Lactic Acid

88% L-lactic acid (ex Purac) was dried using a rotary evaporator and a water cooler. A known amount of lactic acid was placed into a bottle beaker, which was heated in an oil bath under atmospheric pressure. The oil bath was preheated to the drying temperature, which was 155° C. The progress of the drying was followed by collecting and condensing the water distilled from the beaker at short time intervals. When the weight of the condensed water was approximately 12% of the initial weight of the 88% lactic acid, the drying was stopped and the bottle capped, weighed, and allowed to cool to ambient temperature.

### (b) Polymerisation Procedure

The polymerisations were conducted on an oil bath under vacuum using a rotary evaporator and a water cooler. The polymerisation temperature was 180° C., and the oil bath was preheated to this temperature. The system was filled with nitrogen prior to the beginning of the polymerisation and before taking the samples. The pressure setting of the vacuum pump was lowered to 1 mbar stepwise at the beginning of the polymerisation over a period of 4 hours. The actual pressure was approximately 27 mbar after 4 hours, when the pressure setting had just been lowered to 1 bar, but reduced to 3 mbar before taking the first sample after 6 hours. The pressure was 3 mbar also before taking the second sample after 22 hours, but slightly higher, between 6 and 15 mbar, before taking the last 3 samples after 30, 46, and 54 hours.

After the pressure setting had been lowered to 1 mbar, the polymerisations were continued at 180° C. for 50 hours. The vacuum pump was stopped and the beaker removed for taking samples after specific time intervals, after which the pressure was lowered to vacuum immediately. The polymerisation times of the samples were counted from the start of the polymerisation at atmospheric pressure.

### (c) Differential Scanning Calorimetry (DSC)

The Differential Scanning Calorimetry (DSC) instrument used to measure the thermal transitions was as described in Examples 1-9.

### (d) Thermogravimetric Analysis (TGA)

The TGA equipment used was Seiko Instruments TG/DTA 6200 module with an Exstar 6000 base unit. The samples were analysed using Program I (heat from 20° C. to 500° C. at 10° C./minute) or using isothermal analysis, i.e. Program II (heat from 20° C. to 300° C. at 50° C./minute, and then hold at 300° C. for 1 hour).

The results and polymer compositions are shown in Table 2.

TABLE 2

| | | | | Polym. | | Degr. | | | | | Residue at |
|---|---|---|---|---|---|---|---|---|---|---|---|
| | LLA | BTCA | ISB | Time | IDT | Onset | Td5 | Td10 | Td20 | Td50 | 500° C. |
| Ex. No. | (%) | (%) | (%) | (h) | (° C.) | (° C.) | (° C.) | (° C.) | (° C.) | (° C.) | (TG %) |
| 10 | 85.6 | 8.8 | 5.5 | 24 | 205 | 263 | 231 | 257 | 276 | 311 | 2.6 |
| | | | | 54 | 222 | 273 | 259 | 273 | 289 | 319 | 3.0 |
| 11 | 88.3 | 8.8 | 2.8 | 24 | 210 | 274 | 245 | 263 | 282 | 314 | 2.1 |
| 12 | 80.1 | 8.8 | 11.0 | 24 | 199 | 258 | 236 | 255 | 272 | 301 | 4.1 |
| 13 | 90.0 | 4.4 | 5.5 | 54 | 205 | 256 | 232 | 251 | 268 | 293 | 2.4 |
| 14 | 76.8 | 17.6 | 5.5 | 24 | 218 | 277 | 245 | 265 | 286 | 314 | 3.3 |
| 15 | 71.6 | 17.4 | 10.9 | 8.75 | 106 | 241 | 143 | 205 | 252 | 309 | 4.2 |
| | | | | 24 | 204 | 263 | 231 | 260 | 282 | 323 | 4.5 |
| | | | | 34 | 204 | 268 | 247 | 265 | 286 | 326 | 4.7 |
| | | | | 48.5 | 206 | 267 | 244 | 264 | 285 | 326 | 4.3 |
| | | | | 54 | 219 | 268 | 246 | 267 | 289 | 327 | 4.9 |
| 16 | 85.0 | — | 15 | 48 | 168 | 230 | 180 | 211 | 233 | 260 | 1.5 |
| (Comp) | | | | | | | | | | | |
| 17 | 100 | — | — | 54 | 211 | 257 | 228 | 251 | 268 | 296 | 0.5 |
| (Comp) | | | | | | | | | | | |
| 18 | 91.1 | 8.8 | 24 | 217 | 283 | 250 | 270 | 287 | 311 | 0.9 | |
| (Comp) | | | 54 | 232 | 289 | 257 | 276 | 293 | 313 | 0.4 | |

Definitions:
IDT = Initial Decomposition Temperature
Td5 = The temperature, at which the sample has lost 5% of its initial weight
Td10 = The temperature, at which the sample has lost 10% of its initial weight
Td20 = The temperature, at which the sample has lost 20% of its initial weight
Td50 = The temperature, at which the sample has lost 50% of its initial weight
Residue at 500° C. = The weight-% of sample left at 500° C. compared to its initial weight

From these results, it can be seen that the polymers of the present invention have high glass transition temperatures and are resistant to thermal degradation.

### EXAMPLE 19

The procedure described in Examples 10-18 was repeated, using 71.6 w-% LLA, 17.4 w-% BTCA and 10.9 w-%, but carrying out the polymerisation for longer periods. The results are shown in Table 3.

| Polymerisation | Tg from the First | Tg from the Second |
|---|---|---|
| Time (h) | Heating Cycle (° C.) | Heating Cycle (° C.) |
| 6 | 42.2 | 48.6 |
| 22 | 59.7 | 63.3 |
| 30 | 67.9 | 73.6 |
| 46 | 70.2 | 78.8 |
| 54 | 74.2 | 79.8 |

### EXAMPLE 20

70.8 weight % L-lactic acid (dried as described in Examples 10-18), 18.2 weight % 1,2,3,4,5,6-cyclohexanehexacarboxylic acid (HCA), and 10.9 weight % isosorbide (HF-004-046) were polymerised as described in Examples 10-18. The total weight of the batch was 20 g.

When inserting the ingredients into the beaker, a thin layer of HCA fastened on the funnel and the actual amount in the batch can therefore be slightly smaller than the calculated values. The amount was, however, very small and its effect on the batch composition was assumed to be negligible.

The polymer was white coloured and looked cloudy at the beginning of the polymerisation. After 4 hours from the beginning of the polymerisation, the colour had darkened slightly. After approximately 5 hours, the polymer looked completely clear. However, when taking a sample after 6 hours from the start of the polymerisation, it was noticed that the polymer contained a small amount of white particles, and these particles were visible until the polymer become more viscous and started to contain trapped bubbles, which made it impossible to see the colour of the material well enough. All the samples taken were hard and felt brittle after they had cooled down.

Differential Scanning Calorimetry (DSC)

The Tg values for the polymerisation of 70.8 weight % LLA, 18.2 weight % HCA, and 10.9 weight % ISB are shown in Table 4. As can be seen from the table, the values obtained were higher than the ones obtained when using the same weight-% ISB with BTCA as the polyacid. The Tg values rose to a level close to 90° C. at the end of the polymerisation.

TABLE 4

| Polymerisation | Tg from the First | Tg from the Second |
|---|---|---|
| Time (hours) | Heating Cycle (° C.) | Heating Cycle (° C.) |
| 6 | 32.7 | 40.7 |
| 12 | 46.2 | 55.2 |
| 24 | 45.1 | 61.1 |
| 30 | 76.9 | 77.7 |
| 48 | 88.2 | 86.3 |

The Tg values obtained in the polymerisation of 70.8 weight % LLA, 18.2 weight % HCA, and 10.9 weight % ISB after a polymerisation time of about 30 hours were significantly higher than typical Tg values for PLA, and also higher than the ones obtained in the earlier polymerisations with ISB and BTCA.

1. A polymer comprising units derived from: lactic acid; isosorbide; and a polycarboxylic acid having at least three carboxylic acid groups, the lactic acid units comprising at least 50 weight % of the polymer.

2. A polymer according to claim 1, in which the lactic acid units comprise at least 60 weight % of the polymer.

3. A polymer according to claim 1, in which the lactic acid units comprise from 65 to 90 weight % of the polymer.

4. A polymer according to claim 1, in which the lactic acid units comprise from 65 to 75 weight % of the polymer.

5. A polymer according to claim 1, in which the isosorbide units comprise no more than 20 weight % of the polymer.

6. A polymer according to claim 5, in which the isosorbide units comprise from 2 to 20 weight % of the polymer.

7. A polymer according to claim 6, in which the isosorbide units comprise from 2 to 15 weight % of the polymer.

8. A polymer according to claim 6, in which the isosorbide units comprise from 5 to 11 weight % of the polymer.

9. A polymer according to claim 1, in which the polycarboxylic acid or anhydride thereof is a compound having at least three carboxylic acid groups, or is an anhydride of such a compound.

10. A polymer according to claim 9, in which the polycarboxylic acid or anhydride thereof is 1,2,3,4,5,6,-cyclohexanehexacarboxylic acid or 1,2,3,4-butanetetracarboxylic acid, or an anhydride thereof.

11. A polymer according to claim 1, in which the polycarboxylic acid or anhydride units comprise no more than 20 weight % of the polymer.

12. A polymer according to claim 11, in which the polycarboxylic acid or anhydride units comprise from 3 to 20 weight % of units in the polymer.

13. A polymer according to claim 12, in which the polycarboxylic acid or anhydride units comprise from 4 to 18 weight % of units in the polymer.

14. A polymer according to claim 13, in which the polycarboxylic acid or anhydride units comprise from 5 to 11 weight % of units in the polymer.

15. A process for preparing a lactic acid polymer according to claim 1, which comprises polymerising lactide, isosorbide and a polycarboxylic acid having at least three carboxylic acid groups or anhydride thereof, the lactide being present in sufficient amount to provide at least 50 weight % of lactic acid units in the lactic acid polymer.

16. A process according to claim 15, in which the polymerisation is carried out at a temperature of from 100° C. to 250° C.

17. A composition comprising a copolymer according to claim 1 in admixture with at least one polyester.

18. A composition according to claim 17, in which said polyester is a polylactide.

19. A polymer according to claim 9, in which the polycarboxylic acid or anhydride thereof is a compound having from three to six carboxylic acid groups, or is an anhydride of such a compound.
